(19) United States
(12) Patent Application Publication
(10) Pub. No.: US 2015/0168438 A1
(43) Pub. Date: Jun. 18, 2015

(54) ELECTRONIC DEVICE, DATA PROCESSING METHOD AND DATA PROCESSING PROGRAM

(71) Applicant: SEIKO INSTRUMENTS INC., Chiba-shi (JP)

(72) Inventors: Keisuke TSUBATA, Chiba-shi (JP); Hisao NAKAMURA, Chiba-shi (JP); Takanori HASEGAWA, Chiba-shi (JP); Tomohiro IHASHI, Chiba-shi (JP); Katsuya MUGISHIMA, Chiba-shi (JP); Kazuo KATO, Chiba-shi (JP); Akira TAKAKURA, Chiba-shi (JP)

(21) Appl. No.: 14/540,509

(22) Filed: Nov. 13, 2014

(30) Foreign Application Priority Data
Dec. 13, 2013 (JP) 2013-258391

(51) Int. Cl. G01P 3/62; G01C 5/00; G01C 5/06

(52) U.S. Cl. CPC G01P 3/62; G01C 5/06; G01C 5/005

(57) ABSTRACT

To provide an electronic device, a data processing method and a data processing program capable of measuring a stable ascending/descending velocity on which the most recent ascending/descending state is reflected. The electronic device includes an altitude measurement unit measuring altitudes, an altitude change determination unit determining an altitude change state based on altitudes measured by the altitude measurement unit within a predetermined first time interval until a current time and an ascending/descending velocity calculation unit calculating an ascending/descending velocity based on altitudes measured by the altitude measurement unit within a second time interval until the current time, which is equal to the first time interval or longer than the first time interval.

### BACKGROUND OF THE INVENTION

1. Field of the Invention

The present invention relates to an electronic device, a data processing method and a data processing program.

2. Description of Related Art

Hitherto there have been developed an altimeter which measures a pressure of the air (atmospheric pressure) and detects an altitude at that point based on the measured atmospheric pressure and an electronic device having the same function. These electronic devices may be used in outdoor exercises executed in steeply hilly and slanting mountainous areas, which are, for example, mountain climbing, hiking and so on. In these electronic devices, there is one which is downsized and reduced in weight, displaying ascending velocity or descending velocity based on the detected altitude. In the following explanation, the ascending velocity and the descending velocity are generically called “ascending/descending velocity” (also called ascending/descending speed).

For example, in JP-A-63-121778 (Patent Document 1), there is disclosed an electronic timepiece with a pressure sensor including a pressure sensor, a vertical distance calculation means for calculating a vertical distance from a first point to a second point based on a pressure detected by the pressure sensor, a measurement means for measuring a period of time for reaching the second point from the first point and a computing means for calculating an average ascending or descending velocity based on the vertical distance calculated by the vertical distance calculation means and the measured time by the measurement means.

Furthermore, in Japanese Patent No. 4426620 (Patent Document 2), there is disclosed a portable electronic device including a means for calculating a value of a physical size relating to an altitude in a particular instant, an electronic circuit having a time reference and a processing means for processing the value, in which the processing means has an analog display variometer allowing a first display member in analog display members to performs display indicating an instantaneous change rate of altitude and allowing a second display member in the analog display members to perform display indicating an average change rate of altitude in a predetermined time interval.

### SUMMARY OF THE INVENTION

The ascending/descending velocity calculated by the electronic timepiece with the pressure sensor disclosed in Patent Document 1 will be a value obtained by dividing a current altitude (relative altitude) using the altitude at the time of starting measurement as a reference by the time elapsed until the current time. Therefore, an ascending or descending state (hereinafter referred to as an “ascending/descending state”) from the measurement start time until the current time is not sometimes reflected only by the calculated ascending/descending velocity.

In the portable electronic device disclosed in Patent Document 2, the difference of altitudes between time points adjacent to each other with a predetermined time interval is calculated, and the average change rate of altitude is calculated based on the calculated difference of altitudes. The average change rate of altitude corresponds to the ascending/descending velocity. As a minute change of altitude and a change of a walking velocity of a user are reflected on the calculated ascending/descending velocity, the ascending/descending velocity may vary each time. For example, there is a case where the maximum value of the ascending/descending velocity reaches 1.5 to 2.0 times the minimum value even when the slope is almost constant macroscopically. In particular, the phenomenon becomes prominent when the time interval used when calculating the difference of altitudes is short.

The present invention has been made in view of the above circumstances, and an object thereof is to provide an electronic device, a data processing method and a data processing program capable of measuring a stable ascending/descending velocity on which the most recent ascending/descending state is reflected.

According to an embodiment of the present invention, there is provided an electronic device including an altitude measurement unit measuring altitudes, an altitude change determination unit determining an altitude change state based on altitudes measured by the altitude measurement unit within a predetermined first time interval until a current time, and an ascending/descending velocity calculation unit calculating an ascending/descending velocity based on altitudes measured by the altitude measurement unit within a second time interval until the current time, which is equal to the first time interval or longer than the first time interval.

In the above electronic device, when the altitude change determination unit determines that the altitude change state has been changed, the ascending/descending velocity calculation unit may set the second time interval so as to be equal to the first time interval at the time of calculating the ascending/descending velocity.

In the above electronic device, after the altitude change determination unit determines that the altitude change state has been changed, the ascending/descending velocity calculation unit may increase the second time interval in accordance with a lapse of time until reaching the predetermined maximum value of the second time interval at the time of calculating the ascending/descending velocity.

In the above electronic device, when the altitude change determination unit determines that the altitude change state has been changed, the ascending/descending velocity calculation unit may set the second time interval so as to be shorter than the first time interval temporarily at the time of calculating the ascending/descending velocity.

In the above electronic device, the altitude change determination unit may determine the altitude change state by comparing a distribution of altitudes measured by the altitude measurement unit within the predetermined first time interval until the current time with a predetermined range of altitudes around an altitude measured by the altitude measurement unit at the present.

In the above electronic device, the altitude change determination unit may determine the altitude change state by comparing an altitude measured by the altitude measurement unit at a time prior to the current time by the first time interval with an altitude measured by the altitude measurement unit at present.

According to the embodiment of the present invention, there is provided a data processing method in an electronic device, which includes the steps of determining an altitude change state based on altitudes measured by the altitude measurement unit within a predetermined first time interval until a current time, and calculating an ascending/descending velocity based on altitudes measured by the altitude measurement unit within a second time interval until the current time, which is equal to the first time interval or longer than the first time interval.

According to the embodiment of the present invention, there is provided a data processing program of an electronic device for executing the steps of determining an altitude change state based on altitudes measured by the altitude measurement unit within a predetermined first time interval until a current time, and calculating an ascending/descending velocity based on altitudes measured by the altitude measurement unit within a second time interval until the current time, which is equal to the first time interval or longer than the first time interval.

According to the embodiment of the present invention, a stable ascending/descending velocity on which the most recent ascending/descending state is reflected can be measured.

### BRIEF DESCRIPTION OF THE DRAWINGS

FIG. 1 is a front view showing an external structure of an electronic device according to the embodiment of the present invention;

FIG. 2 is a schematic block diagram showing a configuration of the electronic device according to the embodiment;

FIGS. 3A and 3B are graphs showing examples of determining the altitude change state;

FIGS. 4A and 4B are graphs showing examples of setting moving average periods;

FIG. 5A to 5C show examples of information to be displayed on a display section according to the embodiment; and

FIG. 6 is a flowchart showing data processing according to the embodiment.

### DESCRIPTION OF EMBODIMENTS

Hereinafter, an embodiment of the present invention will be explained with reference to the drawings. In respective drawings, the same components are denoted by the same reference numerals.

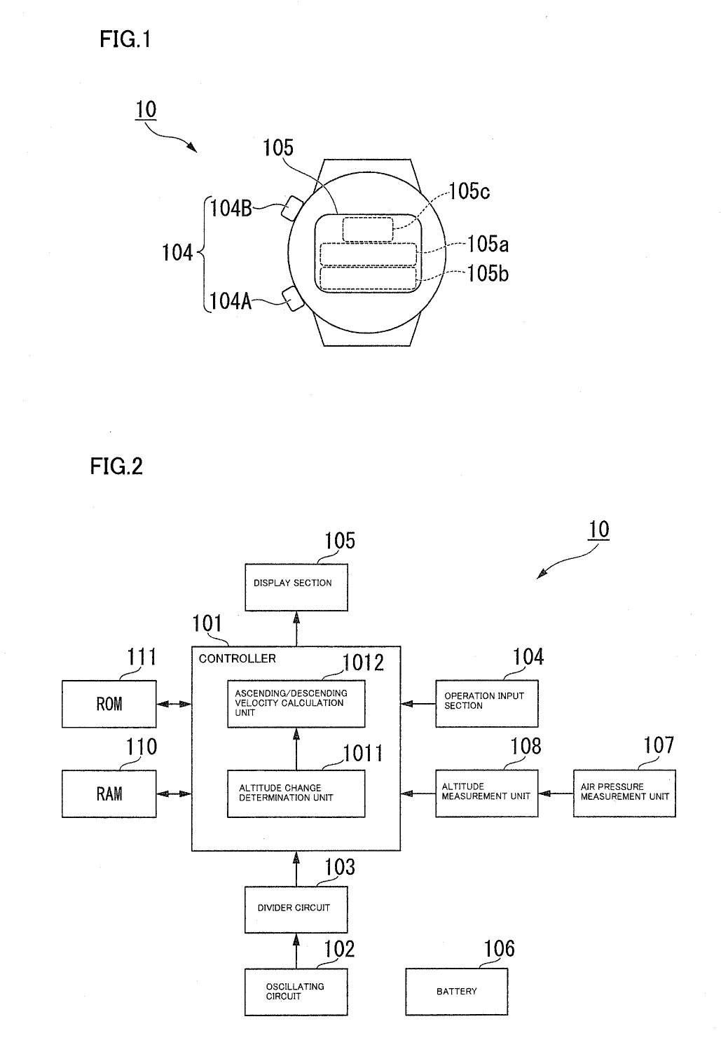

FIG. 1 is a front view of an external structure of an electronic device 10 according to the embodiment.

The electronic device 10 is, for example, an electronic timepiece with an altitude measurement function for measuring altitudes. The electronic device 10 measures a current time and an altitude, calculating an ascending/descending velocity based on the measured altitude.

The electronic device 10 includes an operation input section 104 and a display section 105.

The operation input section 104 includes, for example, plural (two in the embodiment) key input means (operation input sections) 104A and 104B. The key input means 104A and 104B respectively have buttons, receiving operation inputs and outputting operation signals corresponding to the received operation inputs to a controller 101.

The key input means 104A receives an operation of switching operation modes by, for example, the button being pressed. The operation modes included a “normal mode” in which the measured current time, altitude and ascending/descending velocity are displayed and an “altitude log mode” in which altitude information relating to the altitude (for example, the altitude and ascending/descending velocity) is recorded. The electronic device 10 operates in the operation mode switched in accordance with the operation.

The key input means 104B receives the operation of switching information to be displayed on the display section 105 when the electronic device 10 is operated in the altitude log mode by, for example, the button being pressed. The information to be displayed includes, for example, “start time display”, “maximum altitude display” and “current altitude display”. The start time display is altitude information at the time of starting recording. The maximum altitude display is altitude information relating to the maximum altitude in altitudes indicated by the recorded altitude information. The current altitude display is altitude information acquired in a point when the device is operated in the altitude log mode.

The display section 105 displays acquired information. The display section 105 is, for example, a liquid crystal display, a segment display and so on.

The display section 105 includes, for example, an altitude display section 105a, a time display section 105b and an ascending/descending velocity display section 105c. In the example shown in FIG. 1, the ascending/descending velocity display section 105c displaying the ascending/descending velocity, the altitude display section 105a displaying the altitude and the time display section 105b displaying the time are shown in this order.

FIG. 2 is a block diagram showing a configuration of the electronic device 10 according to the embodiment.

The electronic device 10 includes the controller 101, an oscillating circuit 102, a divider circuit 103, the operation input section 104, the display section 105, a battery 106, an air pressure measurement unit 107, an altitude measurement unit 108, a RAM (Random Access Memory) 110 and a ROM (Read Only Memory) 111.

The controller 101 performs control of respective units included in the electronic device 10. The controller 101 is, for example, a CPU (Central Processing Unit).

When considering a functional aspect, the controller 101 includes an altitude change determination unit 1011 and an ascending/descending velocity calculation unit 1012.

The altitude change determination unit 1011 determines an altitude change state based on altitude signals inputted from the altitude measurement unit 108 within a predetermined first time interval (for example, 5 minutes) until the current time.

The altitude change state includes, for example, an “ascending state”, a “descending state” and a “non-ascending/descending state”. The ascending state is a state where the altitude is increased with a lapse of time. The ascending state appears when a user possessing the electronic device 10 is walking on an uphill slope in mountain trails. The descending state may appear when the user possessing the electronic device 10 is walking on a downhill slope in mountain trails. The non-ascending/descending state is a state where a significant change of altitude does not appear, namely, a state of neither the ascending state nor the descending state. The non-ascending/descending state may appear when the user possessing the electronic device 10 is walking on a flatland or taking a rest. Examples of processing for determining the altitude change state will be described later.

The ascending/descending velocity calculation unit 1012 calculates a movement average value of the ascending/descending velocity based on altitude signals inputted from the altitude measurement unit 108 within a second time interval until the current time. The second time interval is a larger value than the first time interval. The second time interval can be variable. When the second time interval is variable, the second time interval can be equal to the first time interval or can be smaller than the first time interval temporarily as long as there is a possibility that the second time interval is set to be larger than the first time interval.

The ascending/descending velocity calculation unit 1012, for example, reduces the second time interval to the first time interval when the altitude change state is changed, and then, increases the second time interval at the same pace as the lapse of time until reaching a predetermined third time interval (the maximum value of the second time interval). An example of processing for calculating the ascending/descending velocity will be described later.

The controller 101 clocks the current time based on a measurement signal inputted from the divider circuit 103. The controller 101 generates altitude information including the calculated movement average value of the ascending/descending velocity and altitudes sampled in the altitude change determination unit 1011. When the device is operated in the normal mode, or when the device is operated in the altitude log mode and the operation signal is not inputted from the key input means 104B, the controller 101 outputs the time information indicating the clocked current time and the generated altitude information to the display section 105, thereby displaying the current time, the altitude and the ascending/descending velocity on the display section 105.

The controller 101 performs processing in accordance with the operation signal inputted from the operation input section 104. For example, when the operation signal (altitude log mode) is inputted from the key input means 104A during the operation in the normal mode, the controller 101 switches the operation mode from the normal mode to the altitude log mode, and starts the operation in the altitude log mode. In the altitude log mode, the controller 101 records the altitude information in the predetermined time interval in the RAM 110 as a log file. On the other hand, when the operation signal (normal mode) is inputted from the key input means 104A during the operation in the altitude log mode, the controller 101 switches the operation mode from the altitude log mode to the normal mode, and stops the recording of altitude information.

When the operation signal (start time display) is inputted from the key input means 104B while the device is operated in the altitude log mode and displays altitude information acquired at present, the controller 101 reads altitude information at a point when the recording is started (start time) from the RAM 110. The controller 101 outputs the read altitude information to the display section 105 to be displayed thereon.

When the operation signal (maximum altitude display) is inputted from the key input means 104B while the device is operated in the altitude log mode and displays altitude information at the start time, the controller 101 reads altitude information relating to the maximum altitude from the RAM 110. The controller 101 outputs the read altitude information to the display section 105 to be displayed thereon.

When the operation signal (current altitude display) is inputted from the key input means 104B while the device is operated in the altitude log mode and displays altitude information relating to the maximum altitude is displayed, the controller 101 outputs the current altitude information to the display section 105 to be displayed thereon.

The oscillating circuit 102 generates an oscillating signal of a given frequency (an oscillating frequency, for example, 32768 Hz) and outputs the generated oscillating signal to the divider circuit 103.

The divider circuit 103 divides the oscillating frequency of the oscillating signal inputted from the oscillating circuit 102 and generates a measurement signal as a reference of measurement having a given frequency (clock frequency, for example, 100 Hz).

The battery 106 supplies the power for the operation to respective units included in the electronic device 10.

The air pressure measurement unit 107 measures an air pressure, outputting an air pressure signal indicating the measured air pressure to the altitude measurement unit 108. The air pressure measurement unit 107 is, for example, an air pressure sensor.

The altitude measurement unit 108 measures an altitude based on the air pressure signal inputted from the air pressure measurement unit 107, outputting an altitude signal indicating the measured altitude to the controller 101. The altitude measurement unit 108 converts an air pressure P indicated by the inputted air pressure signal to an altitude “h” by using, for example, an expression (1) when measuring the altitude.

h={(P₀/P^{(1/5.257})−1}·(T+273.15)/0.0065 (1)

In the expression (1), P₀ represents an air pressure 1013 hPa in a given altitude, for example, an altitude 0 m (sea-level altitude). T represents the temperature (° C.).

The air pressure measurement unit 107 and the altitude measurement unit 108 configure the altimeter measuring altitudes.

The RAM 110 stores data used for the operation in respective units of the electronic device 10 and data generated in respective units. The RAM 110 stores, for example, altitude information as a log file.

In the ROM 111, a program for operations executed by the controller 101 is previously stored. The program for operations is read out when the controller 101 is activated, and the controller 101 executes the processing designated by the read program for operations.

Next, an example of processing for determining the altitude change state by the altitude change determination unit 1011 will be explained.

The altitude change determination unit 1011 samples altitudes indicated by the altitude signals inputted from the altitude measurement unit 108 at every predetermined time interval (sampling interval, for example, 1 minute) ΔT. In the following explanation, the altitude sampled at that point is called a “current altitude”, and the altitude sampled prior to the current altitude is called a “past altitude”. Each time point at which sampling is performed may call “sampling time”.

The altitude change determination unit 1011 determines the altitude change state based on altitudes sampled in an interval from a time t-ΔT1 which is prior to a current time “t” by the predetermined first time interval ΔT1 to the current time “t”. The period from the time t-ΔT1 to the current time “t” is called a “determination period”.

Here, the altitude change determination unit 1011 can determine the altitude change state by comparing a distribution of altitudes sampled in the determination period with a predetermined range of altitudes around a current altitude “h”.

The altitude change determination unit 1011 determines that the altitude change state at the current time “t” is the non-ascending/descending state when all altitudes sampled in the determination period are within a range between a state-determination lower limit value and a state-determination upper limit value.

The state-determination lower limit value is a value h-Δh which is lower than the current altitude “h” by a predetermined altitude Ah. The state-determination upper limit value is a value h+Δh which is higher than the current altitude “h” by the predetermined altitude Δh.

The altitude change determination unit 1011 determines that the altitude change state at the current time “t” is the ascending state when at least one of the altitudes sampled in the determination period is lower than the state-determination lower limit value.

The altitude change determination unit 1011 determines that the altitude change state at the current time “t” is the descending state when at least one of the altitudes sampled in the determination period is higher than the state-determination upper limit value.

The altitudes sampled in the determination period may include both altitudes lower than the state-determination lower limit value and altitudes higher than state-determination upper limit value. In this case, the altitude change determination unit 1011 can determine the altitude change state at the current time “t” based on, for example, an altitude at a time t′ closest to the current time “t” in altitudes lower than the state-determination lower limit value and altitudes higher than the state-determination upper limit value. That is, when the altitude at the time t′ is lower than the state-determination lower limit value, the altitude change determination unit 1011 determines that the altitude change state at the current time “t” is the ascending state. When the altitude at the time t′ is higher than the state-determination upper limit value, the altitude change determination unit 1011 determines that the altitude change state at the current time “t” is the descending state.

Additionally, the altitude change determination unit 1011 may determine the altitude change state at the current time “t” by comparing the number of samples of altitudes lower than the state-determination lower limit value included in altitudes sampled in the determination period with the number of samples of altitudes higher than the state-determination upper limit value. That is, when the number of samples of altitudes lower than the state-determination lower limit value is larger than the number of samples of altitudes higher than the state-determination upper limit value, the altitude change determination unit 1011 determines the state to be the ascending state. When the number of samples of altitudes lower than the state-determination lower limit value is equal to the number of samples of altitudes higher than the state-determination upper limit value, the altitude change determination unit 1011 determines the state to be the non-ascending/descending state. When the number of samples of altitudes lower than the state-determination lower limit value is smaller than the number of samples of altitudes higher than the state-determination upper limit value, the altitude change determination unit 1011 determines the state to be the descending state.

Furthermore, the altitude change determination unit 1011 may determine the state to be the ascending state when an average value of altitudes sampled in the determination period is lower than the state-determination lower limit value, and may determine the state to be the descending state when the average value of altitudes sampled in the determination period is higher than the state-determination upper limit value and may determine the state to be the non-ascending/descending state in cases other than the above.

As described above, the device is hardly affected with respect to a measurement error and noise by comparing the distribution of altitudes sampled in the determination period with the predetermined range of altitudes around the current altitude, therefore, it is possible to determine the altitude change state stably.

The altitude change determination unit 1011 outputs altitude-change state information indicating the determined altitude change state and the sampled altitudes to the ascending/descending velocity calculation unit 1012.

The altitude-change state information may be represented by values corresponding to respective altitude change states. For example, the ascending state, the descending state and the non-ascending/descending state may be respectively represented values such as “+1”, “−1” and “0”.

A period in which the altitude is between the state-determination lower limit value and the state-determination upper limit value and in which the time is between the time t-ΔT1 which is prior to the current time “t” by the predetermined first time interval ΔT1 and the current time “t” is called a “detection window”.

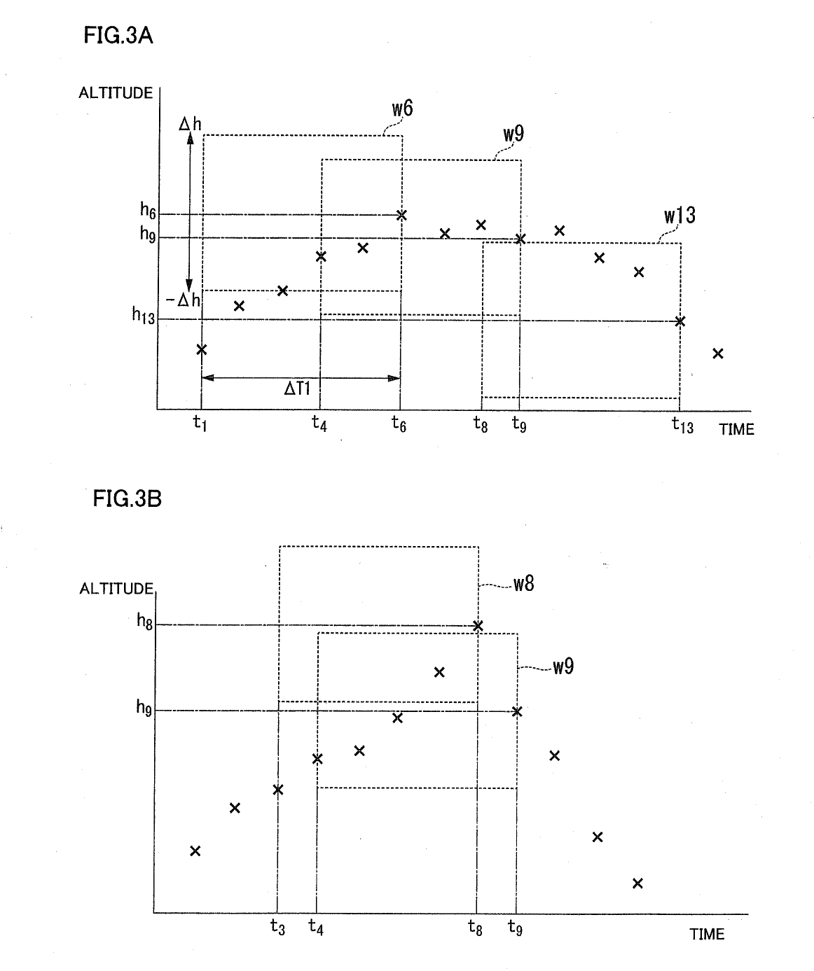

FIGS. 3A and 3B are graphs showing examples of determining the altitude change state.

The horizontal axis and the vertical axis in FIGS. 3A and 3B respectively represent the time and the altitude.

In FIGS. 3A and 3B, altitudes respectively sampled at respective sampling times are represented by marks “x”.

In FIG. 3A, rectangles shown by dashed lines respectively represent detection windows w6, w9, and w13. The detection window 6w represents a determination period in which the time range is t₁ to t₆, which is the period in which the altitude range is h₆-Δh to h₆+Δh. “h₆” represents an altitude at a sampling time t₆. The detection window w6 includes altitudes h₃ to h₆ in altitudes h₁ to h₆ sampled in the determination period, however, altitudes h₁ and h₂ are respectively lower than the detection window w6. Therefore, the altitude change determination unit 1011 determines the altitude change state at the time t₆ to be the “ascending state”.

The detection window w9 is a determination period in which the time range is t₄ to t₉, which is the period in which the altitude range is h₉-Δh to h₉+Δh. “h₉” represents an altitude at a sampling time t₉. The detection window w9 includes all altitudes h₄ to h₉ sampled in the determination period. Therefore, the altitude change determination unit 1011 determines the altitude change state at the time t₉ to be the “non-ascending/descending state”.

The detection window w13 is a determination period in which the time range is t₈ to t₁₃, which is the period in which the altitude range is h₁₃−Δh to h₁₃+Δh. “h₁₃” represents an altitude at a sampling time t₁₃. The detection window w13 includes altitudes h₁₁ to h₁₃ in altitudes h₈ to h₁₃ sampled in the determination period, however, altitudes h₈ and h₁₀ are respectively higher than the detection window w13. Therefore, the altitude change determination unit 1011 determines the altitude change state at the time t₁₃ to be the “descending state”.

In the example shown in FIG. 3A, the determined altitude change state sequentially changes in the order of the “ascending state”, the “non-ascending/descending state” and the “descending state”, however, there is a case where the state changes from the “ascending state” to the “descending state”, or from the “descending state” to the “ascending state”.

In FIG. 3B, rectangles shown by dashed lines respectively represent detection windows w8 and w9. The detection window w8 represents a determination period in which the time range is t₃ to t₈, which is the period in which the altitude range is h₈−Δh to h₈+Δh. “h₈” represents an altitude at a sampling time t₈. The detection window w8 includes altitudes h₇ and h₈ sampled in the determination period, however, altitudes h₃ to h₆ are respectively lower than the detection window w8. Therefore, the altitude change determination unit 1011 determines the altitude change state at the time t₈ to be the “ascending state”.

The detection window w9 is a determination period in which the time range is t₄ to t₉, which is the period in which the altitude range is h₉−Δh to h₉+Δh. “h₉” represents an altitude at a sampling time t₉. The detection window w9 includes altitudes h₄ to h₇ and h₉ sampled in the determination period, however, altitudes h₈ is higher than the detection window w9. Therefore, the altitude change determination unit 1011 determines the altitude change state at the time t₉ to be the “descending state”.

The altitude change determination unit 1011 may determine the altitude change state by comparing the current altitude “h” with an altitude hₜ-Δ_{T1} at the time t-ΔT1 prior to a current time “t” by the predetermined first time interval ΔT1. For example, when the difference between the current altitude “h” and the altitude hₜ-ΔTI at the time t-ΔT1 is larger than a positive threshold in the predetermined altitude difference, the altitude change determination unit 1011 determines the state to be the ascending state. When the difference between the current altitude “h” and the altitude hₜ-ΔT1 at the time t-ΔT1 is smaller than a negative threshold in the predetermined altitude difference, the altitude change determination unit 1011 determines the state to be the descending state. Incases other than the above, the altitude change determination unit 1011 determines the state to be the non-ascending/descending state. As altitudes to be used for determination of the altitude change state is limited to two altitudes, the altitude change determination unit 1011 can determine the altitude change state by simple processing, which suppresses the increase of hardware scale.

Next, an example of processing for calculating the ascending/descending velocity by the ascending/descending velocity calculation unit 1012 will be explained.

In the ascending/descending velocity calculation unit 1012, altitudes sampled at every predetermined sampling interval ΔT are inputted from the altitude change determination unit 1011. The ascending/descending velocity calculation unit 1012 calculates the difference of the current altitude by subtracting a preceding altitude from the inputted current altitude. The preceding altitude is an altitude sampled immediately prior to the current altitude. The ascending/descending velocity calculation unit 1012 calculates the current velocity by dividing the calculated difference by the sampling interval ΔT.

The ascending/descending velocity calculation unit 1012 averages (moving average) ascending/descending velocities calculated in respective samplings in a period from the start time to the current time “t”. The start time is a time t-ΔT2 prior to the current time “t” by the second time interval ΔT2. The ascending/descending velocities in respective samplings are smoothed by performing moving average. In the flowing explanation, a period from the past time t-ΔT2 to the current time “t” is called a “moving average period” and a length of the moving average period is called a “moving average period length”. The moving average period length is ΔT2.

Here, the ascending/descending velocity calculation unit 1012 determines whether the current altitude change state has been changed from the preceding altitude change state or not based on the altitude-change state information inputted from the altitude change determination unit 1011. When it is determined that the altitude change state has been changed, the ascending/descending velocity calculation unit 1012 reduces the moving average period length to the first time interval ΔT1. That is, the moving average period length (second time interval ΔT2) may be equal to the first time interval ΔT1 for a temporal period, however, it is larger than the first time interval ΔT1 in other cases.

When it is determined that the altitude change state has been changed, the ascending/descending velocity calculation unit 1012 may fix the moving average period length to a shorter time interval than the first time interval ΔT1 for a temporal period. The temporal period corresponds to the sampling time at which the altitude change state has been changed or a time point at which a predetermined period of time (for example, the first time interval has passed) from the sampling time. The shorter time interval than the first time interval preferably includes at least two samples within the range, namely, the current time and the preceding sampling time.

Accordingly, when the altitude change state has been changed, it is possible to improve a response until the moving average value of the ascending/descending velocity is displayed by shortening the moving average period length. The past ascending/descending velocity to a time point prior to the current time by the moving average period length, namely, the ascending/descending velocity before the altitude change state is changed is ignored, therefore, the moving average value fitted to realization of a user can be obtained in accordance with the altitude change state at that point. This is particularly effective when the altitude change state is changed from the ascending state to the descending state (refer to FIG. 3B) or the converse case.

When it is determined that the altitude change state has not been changed, the ascending/descending velocity calculation unit 1012 determines whether the moving average period length has reached the predetermined third time interval (the maximum value of the second time interval) or not. When it is determined that the length has reached the third time interval, the ascending/descending velocity calculation unit 1012 does not change the moving average period length. When it is determined that the length has not reached the third time interval, the ascending/descending velocity calculation unit 1012 enlarges the moving average period length at the same pace as the lapse of time. Here, the ascending/descending velocity calculation unit 1012, for example, does not change the sampling time as the start point of the moving average period and fixes the end point of the moving average period as the current sampling time.

As any altitude-change state information does not exist just after the activation of the electronic device 10, the ascending/descending velocity calculation unit 1012 may fix the current ascending/descending velocity to “0 (zero)”. While the current time is from activation to the first time interval, the ascending/descending velocity calculation unit 1012 may fix the current ascending/descending velocity by averaging ascending/descending velocities sampled from the activation to the current time. It is not necessary that the altitude change determination unit 1011 determines the altitude change state during the period.

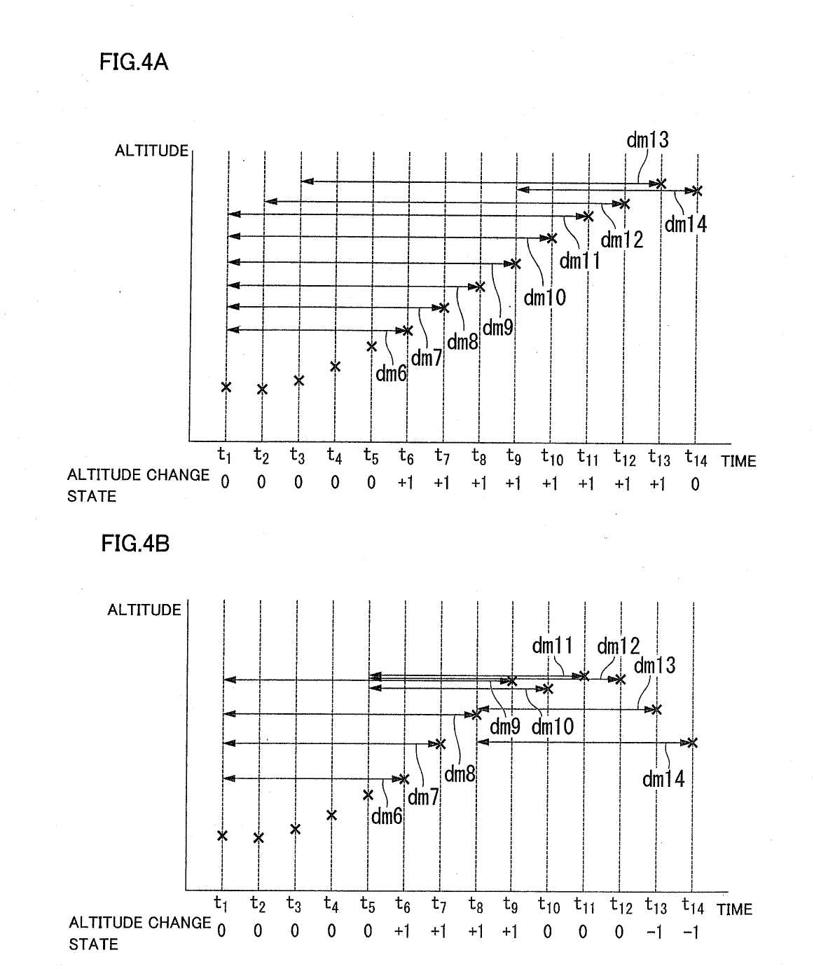

FIGS. 4A and 4B are graphs showing examples of setting moving average periods.

In FIGS. 4A and 4B, altitudes sampled in respective sampling times are shown by marks “x”, and moving average periods relating to the sampling times t₆ to t₁₄ are respectively shown by horizontal arrows dm6 to dm14. The horizontal axis and the vertical axis in FIGS. 4A and 4B respectively represent the time and the altitude. Values of the altitude change state in respective sampling times are shown below the horizontal axis. +1, 0 and −1 respectively represent the ascending state, non-ascending/descending state and the descending state. In the examples shown in FIGS. 4A and 4B, the first time interval and the third time interval are respectively five and ten samples.

FIG. 4A shows that the altitude change state is the non-ascending/descending state (0) in a period from the sampling time ti to the sampling time t₅, the altitude change state is the ascending state (+1) in a period from the sampling time t₆ to the sampling line t₁₃ and the altitude change state is the non-ascending/descending state (0) at the sampling time t_{14.}

The arrow dm6 shows that the moving average period at the sampling time t₆ is a period from t₁ to t₆, which are five samples.

The arrows dm7 to dm11 show that the moving average period length is enlarged on a sample-by-sample basis from the sampling time t₇ to the sampling time t₁₁ at the same pace as the lapse of time. In respective arrows dm7 to dm11, start points of the moving average periods are the same as the start point of the moving average period relating to the arrow dm6 (sampling time t₁). On the other hand, end points of the moving average periods shown by the arrows dm7 to dm11 are current times at respective points (sampling times t₇ to t₁₁). This shows that the ascending/descending velocity calculation unit 1012 has determined that the altitude change state has not been changed and the moving average period length has not reached the third time interval.

The arrows dm12 and dm13 show that moving average periods are fixed to ten samples at the sampling times t12 and t13 respectively, and that the moving average periods are shifted so that end points of the moving average periods becomes current times at respective points. This shows that the ascending/descending velocity calculation unit 1012 has determined that the altitude change state has not been changed and the moving average period length has reached the third time interval.

The arrow dm14 shows that the moving average period at the sampling time t₁₄ is a period from t₉ to t₁₄, which are five samples. This shows that the ascending/descending velocity calculation unit 1012 has reduced the moving average period length to the first time interval in response to the detection of a change in the altitude change state from the ascending state to the non-ascending/descending state.

In the example of FIG. 4A, the moving average period length is reduced to the first time interval in response to the change in the altitude change state after the moving average period length has reached the third time interval, however, the present invention is not limited to this. The moving average period length may be reduced to the first time interval in response to the change in the altitude change state even before the moving average period length reaches the third time interval.

FIG. 4B shows that the altitude change state is the non-ascending/descending state (0) in a period from the sampling time t₁ to the sampling time t₅, the altitude change state is the ascending state (+1) in a period from the sampling time t₆ to the sampling line t₉, the altitude change state is the non-ascending/descending state (0) in a period from the sampling time t₁₀ to the sampling line t₁₂ and the altitude change state is the descending state (−1) at the sampling times t₁₃ and t₁₄.

The arrows dm6 to dm9 show that the moving average period length is enlarged on a sample-by-sample basis from the sampling time t₆ to the sampling time t₉ at the same pace as the lapse of time. This shows that the ascending/descending velocity calculation unit 1012 has determined that the altitude change state has not been changed and the moving average period length has not reached the third time interval.

The arrow dm10 shows that the moving average period at the sampling time t₁₀ is a period from t₅ to t₁₀, which are five samples. This shows that the ascending/descending velocity calculation unit 1012 has reduced the moving average period length to the first time interval in response to the detection of a change of the altitude change state from the ascending state to the non-ascending/descending state.

The arrows dm11 and dm12 show that the moving average period length is enlarged on a sample by sample basis from the sampling time t₁₁ to the sampling time t₁₂ at the same pace as the lapse of time. This shows that the ascending/descending velocity calculation unit 1012 has determined that the altitude change state has not been changed and the moving average period length has not reached the third time interval.

The arrow dm13 shows that the moving average period at the sampling time t₁₃ is a period from t₈ to t₁₃, which are five samples. This shows that the ascending/descending velocity calculation unit 1012 has reduced the moving average period length to the first time interval in response to the detection of a change in the altitude change state from the non-ascending/descending state to the descending state.

The arrow dm14 shows that the moving average period length is enlarged by an interval of one sample at the same pace as the lapse of time at the sampling time t₁₄. This shows that the ascending/descending velocity calculation unit 1012 has determined that the altitude change state has not been changed and the moving average period length has not reached the third time interval.

Next, an example of information to be displayed on the display section 105 will be explained.

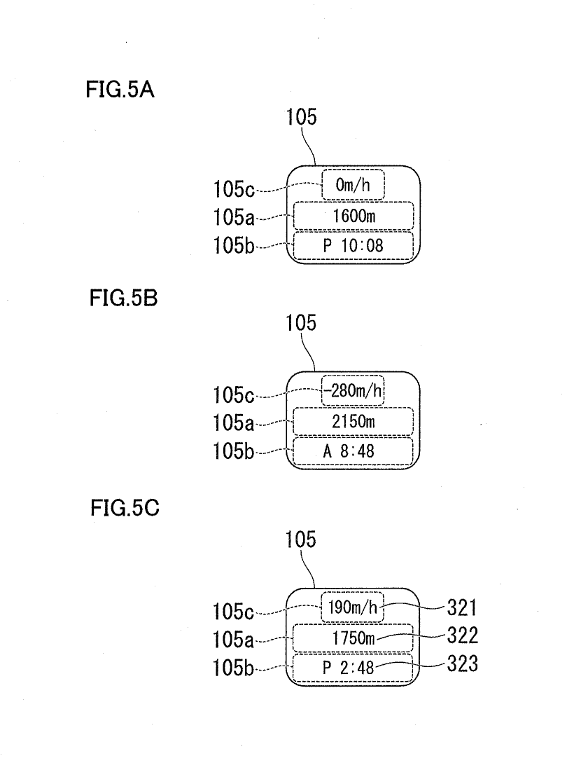

FIGS. 5A to 5C show examples of information to be displayed on the display section 105 according to the embodiment.

In the example shown in FIG. 5A, the display section 105 displays a current ascending/descending velocity “0 m/h” in the ascending/descending velocity display section 105c, displays a current altitude “1600 m” in the altitude display section 105a and displays a current time “P 10:08” in the time display section 105b. “P 10:08” indicates that the current time is 10:08 p.m.

In the example shown in FIG. 5B, the display section 105 displays a current ascending/descending velocity “−280 m/h” in the ascending/descending velocity display section 105c, displays a current altitude “2150 m” in the altitude display section 105a and displays a current time “A 8:48” in the time display section 105b. “−280 m/h” indicates that the descending velocity is 280 m/h. That is, a negative ascending/descending velocity indicates the descending velocity and a positive ascending/descending velocity indicates the ascending velocity. “A 8:48” indicates that the current time is 8:48 a.m.

In the example shown in FIG. 5C, the display section 105 displays a current ascending/descending velocity “190 m/h” in the ascending/descending velocity display section 105c, displays a current altitude “1750 m” in the altitude display section 105a and displays a current time “P 2:48” in the time display section 105b. “190 m/h” indicates that the ascending velocity is 190 m/h. “P 2:48” indicates that the current time is 2:48 p.m.

Next, data processing relating to the embodiment will be explained.

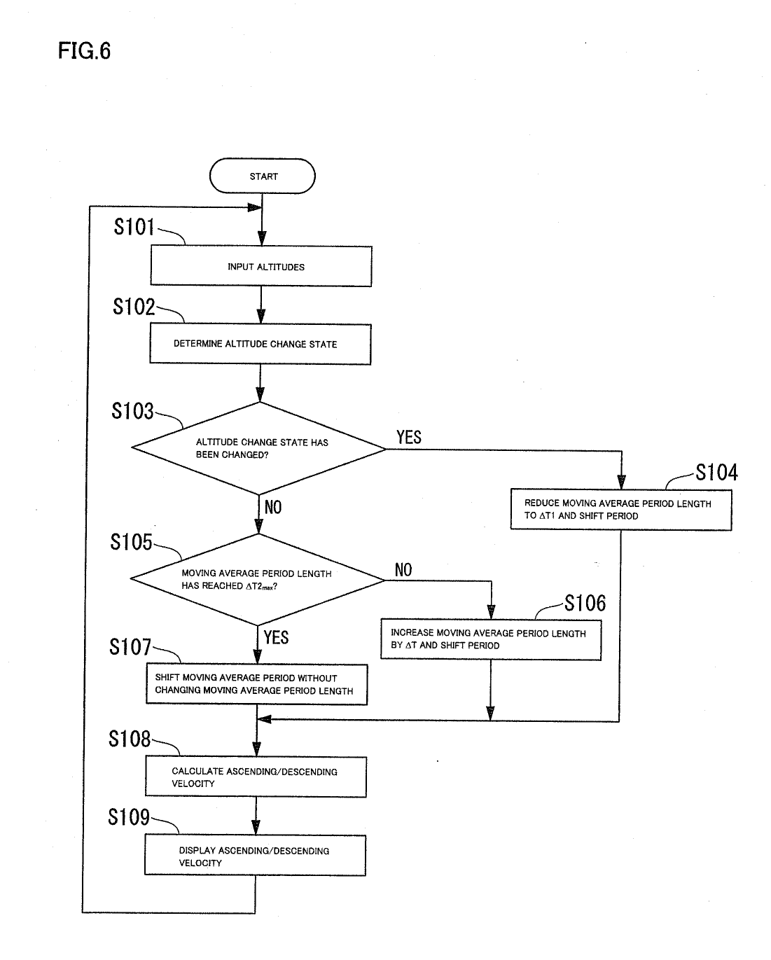

FIG. 6 is a flowchart showing data processing according to the embodiment.

(Step S101) The altitude change determination unit 1011 performs sampling of altitudes indicated by altitude signals inputted from the altitude measurement unit 108 at every predetermined time interval ΔT. After that, the process proceeds to Step S102.

(Step S102) The altitude change determination unit 1011 determines the altitude change state based on altitudes sampled in the determination period from the past time t-ΔT1 to the current time “t”. The altitude change determination unit 1011 determines that the altitude change state at the current time “t” is the non-ascending/descending state“, for example, when all the altitudes sampled in the determination period are within the range from the state determination lower limit value to the state determination upper limit value. The altitude change determination unit 1011 determines that the altitude change state at the current time “t” is the ascending state, for example, when at least one of the altitudes sampled in the determination period is lower than the state determination lower limit value. The altitude change determination unit 1011 determines that the altitude change state at the current time “t” is the descending state, for example, when at least one of the altitudes sampled in the determination period is higher than the state determination upper limit value.

The altitude change determination unit 1011 outputs altitude-change state information indicating the determined altitude change state to the ascending/descending velocity calculation unit 1012. After that, the process proceeds to Step S103.

(Step S103) The ascending/descending velocity calculation unit 1012 determines whether the current altitude change state has been changed from the preceding altitude change state or not based on the altitude-change state information inputted from the altitude change determination unit 1011. When it is determined that the state has been changed (YES in Step S103), the process proceeds to Step S104. When it is determined that the state has not been changed (NO in Step S103), the process proceeds to Step S105.

(Step S104) The ascending/descending velocity calculation unit 1012 reduces the moving average period length to the first time interval ΔT1 and shifts the moving average period so that the end point becomes the current time. After that, the process proceeds to Step 108.

(Step S105) The ascending/descending velocity calculation unit 1012 determines whether the moving average period length has reached the maximum value ΔT2ₘₐₓ of the predetermined second time interval or not. When it is determined that the length has reached the maximum value ΔT2ₘₐₓ (YES in Step S105), the process proceeds to Step S107. When it is determined that the length has not reached (NO in Step S105), the process proceeds to Step S106.

(Step S106) The ascending/descending velocity calculation unit 1012 enlarges the moving average period length at the same pace as the lapse of time (increase the length by the sampling interval ΔT) and shifts the moving average period so that the end point becomes the current time. After that, the process proceeds to Step S108.

(Step S107) The ascending/descending velocity calculation unit 1012 shifts the moving average period so that the end point becomes the current time without changing the moving average period length. After that, the process proceeds to S108.

(Step S108) The ascending/descending velocity calculation unit 1012 calculates the difference of the current altitude by subtracting the preceding altitude from the current altitude in respective samplings, and calculates the current ascending/descending velocity by dividing the calculated difference by the sampling interval ΔT. The ascending/descending velocity calculation unit 1012 averages the ascending/descending velocities in the moving average period until the current time and calculates the moving average value of the ascending/descending velocities. After that, the process proceeds to Step S109.

(Step S109) The controller 101 generates altitude information including the calculated moving average value of the ascending/descending velocities. The controller 101 outputs the generated altitude information to the display section 105 and displays the ascending/descending velocity on the display section 105. After that, the process returns to Step S101, and the processes from Step S102 to Step S109 are repeated at every sampling interval ΔT.

The processing of reducing the moving average period length to the first time interval and shifting the moving average period so that the endpoint becomes the current time (Step S104 of FIG. 6) performed by the ascending/descending velocity calculation unit 1012 can be realized by deleting altitudes and ascending/descending velocities prior to altitudes and so on sampled prior to the current time by the first time interval, which have been stored in the RAM 110. In this case, the altitude change determination unit 1011 stores altitudes sampled at every sampling interval ΔT and the ascending/descending velocity calculation unit 1012 respectively stores the ascending/descending velocities calculated at every sampling interval ΔT in the RAM 110. When calculating moving average values, the ascending/descending velocity calculation unit 1012 uses ascending/descending velocities not deleted and remained in the RAM 110 to thereby calculate these average values as moving average values.

The ascending/descending velocity calculation unit 1012 can also realize the processing of enlarging the moving average period length at the same pace as the lapse of time and shifting the moving average period so that the end point becomes the current time (Step S106 of FIG. 6) by holding altitudes and ascending/descending velocities stored in the RAM 110 without deleting the altitudes and so on.

The ascending/descending velocity calculation unit 1012 can also realize the processing of shifting the moving average period so that the end point becomes the current time without changing the moving average period length (refer to Step S107) by deleting altitudes and ascending/descending velocities stored at the earliest stage in the altitudes and ascending/descending velocities stored in the RAM 110.

As described above, the delay from the acquisition of the current ascending/descending velocity until the moving average value of the ascending/descending velocities are calculated is alleviated by reducing the moving average period length in accordance with the altitude change state (for example, change in the ascending/descending state) by the ascending/descending velocity calculation unit 1012. Accordingly, the moving average value can follow the most recent ascending/descending state. Then, the altitudes used for calculating ascending/descending velocities for performing moving average and the altitudes used for determining the ascending/descending state can be used in common by reducing the moving average period length into the first time interval used for determining the ascending/descending state, therefore, the determined altitude change state can be matched with the calculated ascending/descending velocity.

When the altitude change state indicated by the altitude-change state information is the non-ascending/descending state, the ascending/descending velocity calculation unit 1012 may fix the moving average value of the ascending/descending velocities to “0 (zero)”, and may omit the processing of calculating the moving average value. However, the ascending/descending velocity calculation unit 1012 determines the altitude change state even in that case. When the altitude change state is the non-ascending/descending state, the moving average value of the ascending/descending velocities is not significant for the user, therefore, the throughput can be reduced by omitting the processing relating to the calculation.

As described above, the electronic device 10 according to the embodiment includes an altitude measurement unit (for example, altitude measurement unit 108) measuring altitudes and an altitude change determination unit (for example, the altitude change determination unit 1011) determining an altitude change state based on altitudes measured by the altitude measurement unit within the predetermined first time interval until the current time. The electronic device 10 also includes an ascending/descending velocity calculation unit (for example, the ascending/descending velocity calculation unit 1012) calculating an ascending/descending velocity by using altitudes measured by the altitude measurement unit within the second time interval until the current time, which is equal to the first time interval or longer than the first time interval.

Accordingly, the altitude change state is calculated based on altitudes in the time interval equal to the time interval (second time interval) in which ascending/descending velocities are averaged or shorter than the second time interval (first time interval), therefore, a stable ascending/descending velocity on which the ascending/descending state at that point is reflected can be measured.

Note that the entire or part of functions of respective units included in the electronic device 10 according to the embodiment can be realized by recording a program for executing these functions in a computer readable recording medium and by reading the program recorded in the recording medium in a computer system to execute the program. “The computer system” referred to here includes hardware such as OS and peripheral devices.

The “computer readable recording medium” includes portable media such as a flexible disk, a magneto optical disk, a ROM and a CD-ROM and storage units such as a hard disk built in the computer system. The “computer readable recording medium” may further included media dynamically storing the program for a short period of time such as a communication line used when the program is transmitted through networks such as Internet and communication lines such as a telephone line, and media temporarily storing the program such as a volatile memory inside the computer system to be a server or a client in the above case. The program may be for realizing part of the above functions as well as for realizing the above functions by combination with programs already recorded in the computer system.

The embodiment of the present invention has been explained as the above, and the present invention is not limited to the above embodiment and various modification may add within a scope not departing from the gist of the present invention.

For example, though the number of key input means included in the operation input section 104 is two, the present invention is not limited to this. The number predetermined in accordance with the number of functions possessed by the electronic device 10, for example, one or two or more means can be applied.

Though the electronic device 10 according to the present embodiment is an electronic timepiece with an altitude measurement function, the present invention is not limited to this. Any type of electronic device can be applied as the electronic device 10 as long as the device has the altitude measurement function, and for example, a multifunctional cellular phone (so-called smartphone) may be applied.

What is claimed is:

1. An electronic device comprising:
an altitude measurement unit measuring altitudes;
an altitude change determination unit determining an altitude change state based on altitudes measured by the altitude measurement unit within a predetermined first time interval until a current time; and
an ascending/descending velocity calculation unit calculating an ascending/descending velocity based on altitudes measured by the altitude measurement unit within a second time interval until the current time, which is equal to the first time interval or longer than the first time interval.

2. The electronic device according to claim 1,
wherein, when the altitude change determination unit determines that the altitude change state has been changed, the ascending/descending velocity calculation unit sets the second time interval so as to be equal to the first time interval at the time of calculating the ascending/descending velocity.

3. The electronic device according to claim 2,
wherein, after the altitude change determination unit determines that the altitude change state has been changed, the ascending/descending velocity calculation unit increases the second time interval in accordance with a lapse of time until reaching the predetermined maximum value of the second time interval at the time of calculating the ascending/descending velocity.

4. The electronic device according to claim 1,
wherein, when the altitude change determination unit determines that the altitude change state has been changed, the ascending/descending velocity calculation unit sets the second time interval so as to be shorter than the first time interval temporarily at the time of calculating the ascending/descending velocity.

5. The electronic device according to claim 1,
wherein the altitude change determination unit determines the altitude change state by comparing a distribution of altitudes measured by the altitude measurement unit within the predetermined first time interval until the current time with a predetermined range of altitudes around an altitude measured by the altitude measurement unit at present.

6. The electronic device according to claim 1,
wherein the altitude change determination unit determines the altitude change state by comparing an altitude measured by the altitude measurement unit at a time prior to the current time by the first time interval with an altitude measured by the altitude measurement unit at present.

7. A data processing method in an electronic device, comprising the steps of:
determining an altitude change state based on altitudes measured by the altitude measurement unit within a predetermined first time interval until a current time; and
calculating an ascending/descending velocity based on altitudes measured by the altitude measurement unit within a second time interval until the current time, which is equal to the first time interval or longer than the first time interval.

8. A data processing program of an electronic device for executing the steps of:
determining an altitude change state based on altitudes measured by the altitude measurement unit within a predetermined first time interval until a current time; and
calculating an ascending/descending velocity based on altitudes measured by the altitude measurement unit within a second time interval until the current time, which is equal to the first time interval or longer than the first time interval.

9. An electronic device comprising:
an input unit receiving an input to a controller;
an altitude measurement unit measuring altitude;
an altitude change determination unit in the controller determining an altitude change state whether to ascending or descending based on altitude measured by the altitude measurement unit within a predetermined first period until the point the input unit receiving the input;
an velocity calculation unit in the controller calculating a velocity based on altitude measured by the altitude measurement unit within a second period until the point the input unit receiving the input, which is equal to the first period or longer than the first period; and
a display unit displaying the output the altitude change determination unit and the velocity calculation unit output.
